(19) United States
(12) Patent Application Publication
(10) Pub. No.: US 2016/0295461 A1
(43) Pub. Date: Oct. 6, 2016

(54) MITIGATING EXCESSIVE HANDOVERS

(71) Applicant: BROADCOM CORPORATION, Irvine, CA (US)

(72) Inventors: Fu-Hsuan CHIU, Berkeley Heights, NJ (US); Guosen YUE, Edison, NJ (US)

(21) Appl. No.: 14/726,988

(22) Filed: Jun. 1, 2015

Related U.S. Application Data
(60) Provisional application No. 62/142,829, filed on Apr. 3, 2015.

(51) Int. Cl. H04W 36/00

(52) U.S. Cl. CPC H04W 36/0005

(57) ABSTRACT

A device for mitigating excessive handovers may include at least one processor circuit. The at least one processor circuit may be configured to receive information from a user equipment. The at least one processor circuit may be configured to determine that a first handover of the user equipment from a first base station has occurred, based at least on the information received from the user equipment. The at least one processor circuit may be configured to prevent a second handover of the user equipment back to the first base station until at least one condition has occurred.

### CROSS-REFERENCE TO RELATED APPLICATIONS

This application claims the benefit of U.S. Provisional Patent Application No. 62/142,829, filed on Apr. 3, 2015, entitled “Mitigating Excessive Handovers,” which is hereby incorporated by reference in its entirety.

### TECHNICAL FIELD

The present description relates generally to wireless communications, including mitigating excessive handovers.

### BACKGROUND

A cellular network may facilitate wireless connectivity of wireless devices at various geographic areas. The cellular network includes cells, where each cell may provide coverage for wireless devices located within a geographic area. The coverage areas provided by the cells may overlap each other.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment in which a system for mitigating excessive handovers may be implemented in accordance with one or more implementations.

FIG. 2 illustrates a flow diagram of an example process of a serving base station in a system for mitigating excessive handovers in accordance with one or more implementations.

FIG. 3 illustrates a flow diagram of an example process of a serving base station in a system for mitigating excessive handovers in accordance with one or more implementations.

FIG. 4 illustrates a flow diagram of an example process of a serving base station in a system for mitigating excessive handovers in accordance with one or more implementations.

FIG. 5 conceptually illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more implementations. In one or more instances, structures and components are shown in block diagram form in order to avoid obscuring the concepts of the subject technology. One or more implementations of the subject disclosure are illustrated by and/or described in connection with one or more figures and are set forth in the claims.

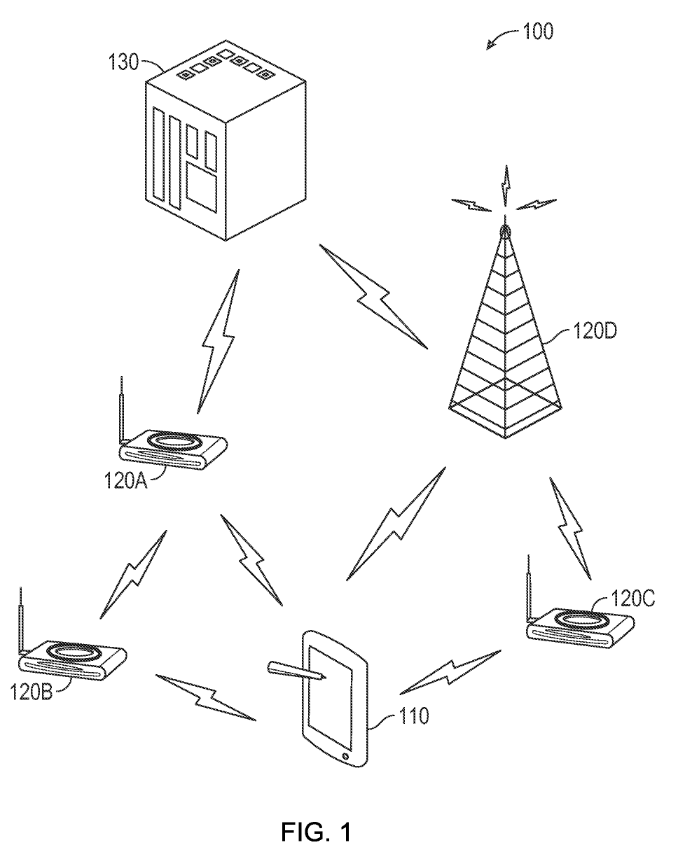

FIG. 1 illustrates an example network environment 100 in which a system for mitigating excessive handovers may be implemented in accordance with one or more implementations. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

The example network environment 100 includes a user device 110, base stations 120A-D, and network management system 130. The user device 110 may include, may be a component of, and/or may be referred to as, a User Equipment (UE). The user device 110 includes suitable logic, circuitry, interfaces, memory, and/or code that enables communications, e.g., with one or more of the base stations 120A-D, via wireless interfaces and utilizing one or more radio transceivers. The user device 110 may also be operable to communicate wirelessly with one or more other user devices and/or one or more other base stations not shown in FIG. 1.

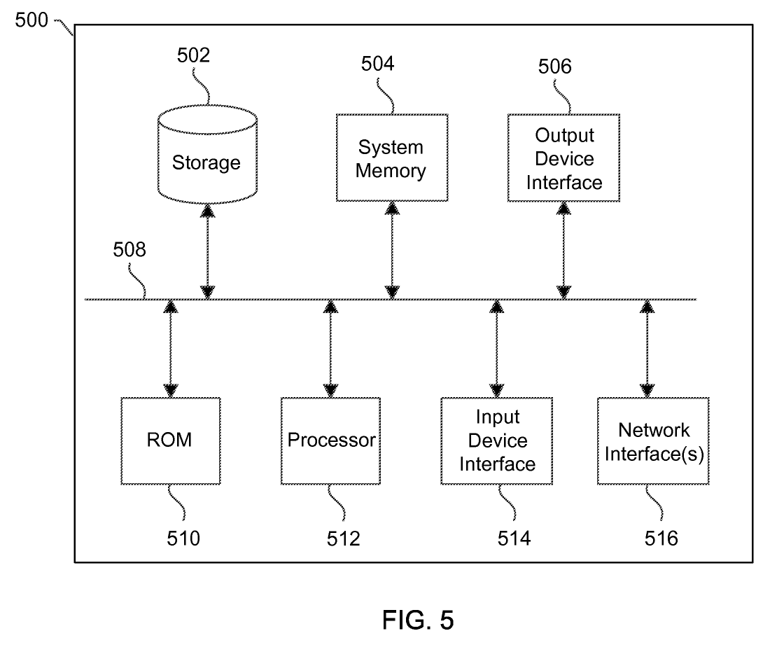

The user device 110 may be, and/or may include, a mobile phone, a personal digital assistant (PDA), a tablet device, a computer, or generally any device that is operable to communicate wirelessly with one or more of the base stations 120A-D. The user device 110 may be, and/or may include one or more components of, the system discussed below with respect to FIG. 5.

One or more of the base stations 120A-D may include, may be a component of, and/or may be referred to as, a cell, a Node B (NB), an Evolved NodeB (eNodeB or eNB), or a Home eNB (HeNB). One or more of the base stations 120A-D includes suitable logic, circuitry, interfaces, memory, and/or code that enable communications, e.g., with the user device 110, one of the other base stations 120A-D, and/or the network management system 130, via wireless interfaces and utilize one or more radio transceivers. One or more of the base stations 120A-D is also operable to communicate wirelessly with one or more other user devices and/or one or more other base stations not shown in FIG. 1. One or more of the base stations 120A-D may be, and/or may include one or more components of, the system discussed below with respect to FIG. 5.

In one or more implementations, one or more of the base stations 120A-D is a base station of a cellular-based wireless network, such as a Long Term Evolution (LTE) communications network, or generally any cellular-based communications network. In the example depicted in FIG. 1, the base stations 120A-C are small cell base stations, such as picocell and/or femtocell base stations, and the base station 120D is a large cell base station, such as a macrocell base station, that provides coverage over a larger area than the base stations 120A-C. For example, the macrocell base station may provide coverage over a radial range of up to tens or hundreds of kilometers; the picocell base station may provide coverage over a radial range in the hundreds of meters; and the femtocell base station may provide coverage over a radial range in the tens of meters.

The network management system 130 may be, may include, and/or may be a component of, a core network for processing information from one or more of the base stations 120A-D and managing connections of user devices (e.g., the user device 110) to the base stations 120A-D. For example, the network management system 130 may be, may include, may be a component of, and/or may be in communication with, a mobile telephone switching office (MTSO). The network management system 130 includes suitable logic, circuitry, interfaces, memory, and/or code that enable communications, e.g., with one or more of the base stations 120A-D, via wireless interfaces and utilize one or more radio transceivers. The network management system 130 may be, and/or may include one or more components of, the system discussed below with respect to FIG. 5.

The base stations 120A-D may be in communication with the network management system 130 through a backhaul network. The network management system 130 may be in direct communication with one or more of the base stations 120A-D or in communication with one or more of the base stations 120A-D through one or more intermediary base stations. For example, in FIG. 1, the network management system 130 is in direct communication with the base stations 120A and 120D, whereas the network management system 130 is in communication with the base station 120B through the base station 120A and the base station 120C through the base station 120D. Although FIG. 1 illustrates one example backhaul network configuration, other network configurations may be utilized to allow communication between the base stations 120A-D and the network management system 130, including but not limited to a star configuration, ring configuration, daisy-chain configuration, and so forth.

The user device 110 monitors the strength of signals transmitted by the base stations 120A-D. If the base station 120A receives comparative signal strengths from the user device 110 for the base stations 120A-B, the base station 120A and/or the network management system 130 may determine that the base stations 120A-B can be referenced as neighboring base stations. In one or more implementations, the user device 110, and/or other user devices, report the measured signal strengths to one or more of the base stations 120A-D. The base stations 120A-D may determine the neighbor relationships based on the received signal strengths, and/or the network management system 130 may determine the neighbor relationships based on these signal strengths (e.g., as relayed to the network management system 130 by the base stations 120A-D). The base stations 120A-D may individually store or otherwise have access to an automatic neighbor relation (ANR) table that includes neighboring relationships with other base stations, e.g. as determined based on the measured signal strengths from the user device 110, and that is used to facilitate managing handovers of user devices served by the base stations 120A-D. In some aspects, the network management system 130 may create, store, maintain, and/or update the ANR table.

In the example network environment 100, the user device 110 may be handed over from one base station 120A to another base station 120B, e.g., as the user device 110 moves around the example network environment 100 and/or when interference conditions at the user device 110 from one or more of the base stations 120A-D fluctuate. A handover of the user device 110 may occur based at least on acquisition and measurement (e.g., power measurement) of signals from two or more of the base stations 120A-D by the user device 110. For example, the user device 110 may be handed over from the base station 120A to the base station 120B based at least on a comparison of signal strengths of the base stations 120A-B as measured by the user device 110.

When the user device 110 is located within an overlapping coverage area of two or more of the base stations 120A-D, the user device 110 may experience repeated and excessive handovers that occur consecutively between two or more base stations 120A-D. The repeated handovers of the user device 110 may be referred to as handover oscillation or ping-pong handover events, and may adversely affect the data throughput to and from the user device 110.

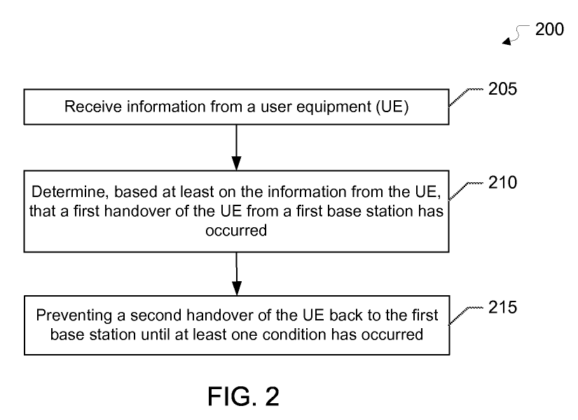

One or more of the base stations 120A-D may implement the subject system for mitigating excessive handovers in order to reduce, or prevent, the number of repeated handovers experienced by the user device 110. In one or more implementations of the subject system, when the user device 110 is handed over from the base station 120B to the base station 120A, the base station 120A may not hand over the user device 110 back to the base station 120B unless one or more conditions are met and/or one or more criteria are satisfied, as is discussed in more detail below with respect to FIGS. 2-4. In this manner, the number of ping-pong handover events experienced by the user device may be reduced.

FIG. 2 illustrates a flow diagram of an example process 200 of a serving base station in a system for mitigating excessive handovers in accordance with one or more implementations. For explanatory purposes, the example process 200 is described herein with reference to the base station 120A of the example network environment 100 of FIG. 1; however, the example process 200 is not limited to the base station 120A of the example network environment 100 of FIG. 1, and the example process 200 may be performed by one or more components of the base station 120A, such as a base station processor and/or a cellular radio module. Furthermore, in one or more implementations, one or all of the blocks of the example process 200 may be performed by one or more components of the network management system 130. The blocks of example process 200 are described herein as occurring in serial, or linearly. However, multiple blocks of example process 200 may occur in parallel. In addition, the blocks of example process 200 need not be performed in the order shown and/or one or more of the blocks of example process 200 need not be performed.

Further for explanatory purposes, for the example process 200 the base station 120A is the serving base station for the user device 110 and the base stations 120B-D are neighboring base stations of the base station 120A. However, in one or more implementations, one or more of the base stations 120B-D may also be the serving base station of the user device 110.

The base station 120A receives information from the user device 110 (205). The user device 110 may provide the information to the base station 120A periodically and/or upon a request by the base station 120A for the information. In one or more implementations, the information may include UE history information indicating which base stations have served as a serving base station for the user device 110, including an order in which the base station served as the serving base station. For example, the UE history information may be, and/or may include, a report with an ordered listing of prior serving base stations of the user device 110 and respective durations of the user device 110 having been served by the respective base stations.

The information received from the user device 110 also may be, may include, or may be utilized by the base station 120A to derive, one or more metrics. The metrics may be signal measurements and/or signal statistics from the user device 110. The signal measurements and/or signal statistics may include power values, time values, and/or signal strength values. For example, the signal measurements may be in the form of a UE report of the serving base station's reference signal received power (RSRP) generated by the user device 110 and provided to the base station 120A, and the base station 120A derives RSRP statistics (e.g., RSRP variance) from the RSRP reports provided by the user device 110. Alternatively and/or in addition, the signal measurements may be in the form of the serving base station's RSRP statistics generated by the user device 110 and provided to the base station 120A. In one or more implementations, signal measurements for one or more neighboring base stations (e.g., the base station 120D) of the base station 120A may also be received by the base station 120A from the user device 110.

The metrics may be, and/or may include, the RSRP variance. The RSRP variance may be determined, e.g., by the user device 110 and/or the base station 120A, based on measured RSRP values and/or interpolated RSRP values. For RSRP values measured by the user device 110 at a time t=t₁ and a time t=t₂, where t₂>t₁, interpolation, e.g., linear, may be performed on the RSRP values measured at t₁ and t₂ to generate additional RSRP values. The number of interpolated RSRP values obtained may be ceiling((t₂−t₁)/T_{S}), where ceiling(x) is the largest integer not greater than x and T_{S} is a fixed time interval. Thus, in a case with RSRP values measured at t=t₁, t₂, . . . , tₙ, the number of RSRP values obtained through measurement and interpolation may be ceiling((tₙ−t₁)/T_{S}).

Alternatively and/or in addition to RSRP statistics, other metrics associated with reference signal received quality (RSRQ), signal-to-interference-plus-noise ratio (SINR), and/or round trip delay (RTT) may be received, and/or derived from the information received, from the user device 110. Similar to the RSRP variance described above, other metrics may be based on values measured by the user device 110 and/or values interpolated from the measured values. The RTT may be determined by the base station 120A based on a timing difference between receive (RX) subframes and transmit (TX) subframes as measured by the user device 110 and/or the base station 120A. Based on the timing differences as measured by the user device 110, the base station 120A may determine the RTT. Since the RTT is indicative of a change in location of the user device 110 over time, RTT statistics (e.g., RTT variances) may be utilized as a measure of mobility of the user device 110.

The base station 120A determines that a handover of the user device 110 from the base station 120B to the base station 120A has occurred (210). The handover of the user device 110 from the base station 120B to the base station 120A may be the most recent handover of the user device 110. The base station 120A may determine that the handover from the base station 120B has occurred based at least on the information received from the user device 110, such as the UE history information.

Based on the determination that the user device 110 was handed over to the base station 120A from the base station 120B, the base station 120A prevents a handover of the user device 110 back to the base station 120B unless (or until) one or more conditions have occurred and/or until one or more criteria have been satisfied (215). The prevention of the handover back to the base station 120B until one or more conditions have occurred and/or one or more criteria have been satisfied may facilitate mitigating excessive handovers, including mitigating ping-pong handover events. In one or more implementations, once the conditions have occurred and the criteria have been satisfied, a handover of the user device 110 back to the base station 120B is no longer prevented (e.g., such a handover is allowed).

In one or more implementations, the base station 120A prevents a handover of the user device 110 back to the base station 120B until a set time duration has elapsed. The base station 120A may set the time duration based on the information received from the user device 110. The time duration may be based on one or more metrics (e.g., RSRP, RSRQ, SINR) received from the user device 110. For example, the time duration may be inversely proportional to a mobility of the user device 110, where higher mobility is associated with, e.g., higher RSRP variances and/or higher RTT variances. Alternatively, the time duration may be a fixed duration. In some aspects, the time duration may be set to 500 ms or longer. The time duration may be set and/or adjusted (e.g., adaptively during operation of the base station 120A) based on performance metrics of the base station 120A. The performance metrics may include a ping-pong handover event rate of the base station 120A at a certain instance in time and/or a target ping-pong handover event rate to be achieved by the base station 120A. The ping-pong handover event rate may be ratio of a number of ping-pong handover events to a number of all handovers for the base station 120A.

In one or more implementations, to facilitate prevention of a handover of the user device 110 back to the base station 120B, the base station 120A updates a table, such as an ANR table, to remove a neighboring relationship with the base station 120B such that the base station 120B is not referenced as a neighboring base station of the base station 120A. In one or more implementations, the base station 120A adds the base station 120B back to the table as a neighboring base station of the base station 120A after the set time duration has elapsed. The table may be utilized by the base station 120A to facilitate mitigating excessive handovers for the user device 110 (e.g., by preventing repeated handovers back to another base station), and may be stored in memory of the base station 120A or in memory otherwise accessible to the base station 120A.

The base station 120A may create a copy of the ANR table, which allows managing handovers of all the UEs, including the user device 110, to create a UE-specific neighbor relation table that is specific to the user device 110. The base station 120A may then update the UE-specific neighbor relation table to remove a neighboring relationship with neighboring base stations of the base station 120A to which a handover of the user device 110 from the base station 120A is being prevented. Alternatively or in addition to the UE-specific neighbor relation table, in one or more implementations, the base station 120A updates a table (e.g., an exclusion table) to include the base station 120B as an excluded neighboring base station of the base station 120A for which a handover from the base station 120A is being prevented until the set time duration has elapsed. In such implementations, the base station 120A may remove the base station 120B from the exclusion table when the set time duration has elapsed.

In one or more implementations, one or all of the blocks of the example process 200 may be performed by the network management system 130. The network management system 130 may receive information from the user device 110 (205) via the base station 120A. For example, the base station 120A may relay information (e.g., serving base station's RSRP reports) from the user device 110 to the network management system 130, e.g. from which the network management system 130 may derive one or more metrics (e.g., RSRP variance), and/or the base station 120A may derive the metrics and provide the derived metrics to the network management system 130. The network management system 130 may determine that the handover from the base station 120B has occurred (210), e.g., based at least on the information relayed to the network management system 130 by the base station 120A.

Based on the determination, the network management system 130 may prevent a handover of the user device 110 from the base station 120A back to the base station 120B unless (or until) one or more conditions have occurred and/or until one or more criteria have been satisfied (215). For example, the network management system 130 may determine and set a time duration in the base station 120A that prevents the base station 120A from handing over the user device 110 back to the base station 120B until the time duration has elapsed, and/or the network management system 130 may instruct the base station 120A to determine and/or set the time duration. The network management system 130 may create, store, maintain, and/or update UE-specific tables (e.g., neighbor relation tables, exclusion tables) that include neighboring relationships of the base stations 120A-D. Once the conditions have occurred and the criteria have been satisfied, the base station 120A is no longer prevented from handing over the user device 110 back to the base station 120B.

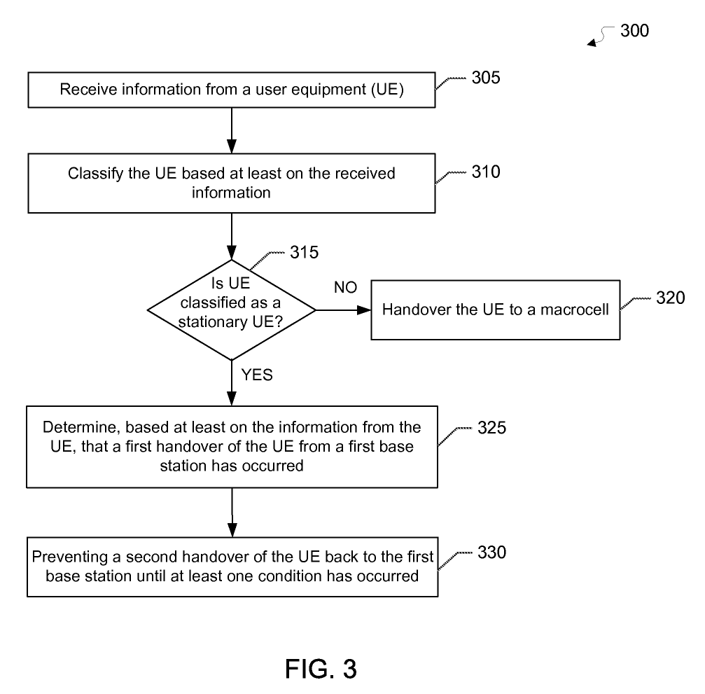

FIG. 3 illustrates a flow diagram of an example process 300 of a serving base station in a system for mitigating excessive handovers in accordance with one or more implementations. For explanatory purposes, the example process 300 is described herein with reference to the base station 120A of the example network environment 100 of FIG. 1; however, the example process 300 is not limited to the base station 120A of the example network environment 100 of FIG. 1, and the example process 300 may be performed by one or more components of the base station 120A, such as a base station processor and/or a cellular radio module. Furthermore, in one or more implementations, one or all of the blocks of the example process 300 may be performed by one or more components of the network management system 130. The blocks of example process 300 are described herein as occurring in serial, or linearly. However, multiple blocks of example process 300 may occur in parallel. In addition, the blocks of example process 300 need not be performed in the order shown and/or one or more of the blocks of example process 300 need not be performed. Furthermore, some of the blocks of example process 300 may be performed in a manner similar to corresponding blocks of example process 200 of FIG. 2.

Further for explanatory purposes, for the example process 300 the base station 120A is the serving base station for the user device 110 and the base stations 120B-D are neighboring base stations of the base station 120A. However, in one or more implementations, one or more of the base stations 120B-D may also be the serving base station of the user device 110.

The base station 120A receives information from the user device 110 (305). The information may be, and/or may include, UE history information indicating which base stations have served as a serving base station for the user device 110. The information may be, may include, or may be utilized by the base station 120A to derive, one or more metrics (e.g., RSRP, RSRQ, SINR, RTT).

The base station 120A classifies the user device 110 based at least on the information received from the user device 110 (310). The classification may be based on the received metrics, e.g., the serving base station RSRP variances. In one or more implementations, the user device 110 is classified as a type of device (also referred to as a UE type), such as a high mobility device, a normal (or average) mobility device, or a stationary (e.g., no mobility or low mobility) device. The base station 120A may classify the user device 110 as a stationary device when a serving base station RSRP variance is below a first predetermined threshold variance; a high mobility device when the serving base station RSRP variance is above a second predetermined threshold variance that is higher than the first predetermined threshold variance; and a normal mobility device otherwise (e.g., when the serving base station RSRP variance is between the first and second predetermined threshold variances).

In one or more implementations, the first and/or second predetermined threshold variances is based on T_{S}, which is the time interval that determines the number of RSRP values generated by interpolation of measured RSRP values. The first and/or second predetermined threshold variances may also be based on the number of RSRP values generated by interpolation. The RSRP value change, in decibels, may be proportional by B×10×log₁₀(r), where r is a distance of movement of the user device 110 and B is an attenuation factor. In some cases, with indoor propagation between the user device 110 and the base station 120A, the attenuation factor B may be around 2. When the user device 110 is 10 m to 20 m from the base station 120A (e.g., an HeNB) with indoor propagation, the first predetermined threshold variance for ten samples may be 5 or less.

The classification of the user device 110 may be based on the received metrics associated with one or more neighboring base stations (e.g., the base stations 120B-D) of the serving base station 120A. For example, the classification may be based on the serving base station RSRP variances and/or RSRP variances of one or more neighboring base stations 120B-D. For explanatory purposes, RSRP is utilized in the classification of the neighboring base stations 120B-D; however, other metrics (e.g., RSRQ, SINR, RTT) may be utilized alternatively or in addition to the RSRP.

In some aspects, the classification is based on multiple metrics individually and/or a weighted sum of multiple metrics. The base station 120A may classify the user device 110 as a stationary device when each of the serving base station RSRP variance, a neighboring base station RSRP variance, and an RTT variance is below a corresponding predetermined threshold. Alternatively or in addition, the base station 120A may classify the user device 110 as a stationary device based on a weighted sum of the serving base station RSRP variance and a serving base station RSRQ variance.

Although example classifications and conditions for the classifications are provided above, additional, different, or fewer classifications and/or conditions for the classifications may be utilized. The classifications and/or associated conditions (e.g., predetermined thresholds) may be set and/or adjusted (e.g., adaptively during operation of the base station 120A) based on performance metrics of the base station 120A, including a ping-pong handover event rate and/or a target ping-pong handover event rate of the base station 120A. For example, the conditions may be adjusted such that more or fewer user devices are classified as stationary devices.

The base station 120A determines if the user device 110 is classified as a stationary mobility device (315). If the user device 110 is not classified as a stationary mobility device (e.g., normal mobility device, high mobility device), the base station 120A may hand over the user device 110 to a macrocell (e.g., the base station 120D) (320). In some aspects, the base station 120A may handle a normal mobility device differently from a high mobility device. For example, the base station 120A may hand over the user device 110 to a macrocell when the user device 110 is classified as a high mobility device. In contrast, the base station 120A might not hand over the user device 110 to a macrocell when the user device 110 is classified as a normal mobility device unless frequent handovers of the user device 110 among several base stations have been detected within a short period of time. Such a handover to a macrocell may prevent frequent handovers among smaller cell networks (e.g., the base stations 120A-C) for a user device 110 with normal or high mobility.

If the user device 110 is classified as a stationary mobility device, the base station 120A determines that a handover of the user device 110 from the base station 120B to the base station 120A has occurred (325). The handover of the user device 110 from the base station 120B to the base station 120A may be the most recent handover of the user device 110. The base station 120A may determine that the handover from the base station 120B has occurred based at least on the information received from the user device 110, such as the UE history information.

Based on the determination that the user device 110 was handed over to the base station 120A from the base station 120B, the base station 120A prevents a handover of the user device 110 back to the base station 120B unless (or until) one or more conditions have occurred and/or until one or more criteria have been satisfied (330). The prevention of the handover back to the base station 120B until one or more conditions have occurred and/or one or more criteria have been satisfied may facilitate mitigating excessive handovers, including mitigating ping-pong handover events.

In one or more implementations, the base station 120A prevents a handover of the user device 110 back to the base station 120B until a set time duration has elapsed. The base station 120A may set the time duration based on the information (e.g., RSRP, RSRQ, SINR) received from the user device 110. Alternatively or in addition, to facilitate prevention of a handover of the user device 110 back to the base station 120B, the base station 120A updates a table to remove a neighboring relationship with the base station 120B and/or updates a table to exclude the base station 120B as a possible target serving base station. In such implementations, the base station 120A may add the base station 120B back to the table as a neighboring base station of the base station 120A after the set time duration has elapsed.

In one or more implementations, the base station 120A prevents a handover of the user device 110 back to the base station 120B when a number of repeated handovers between the base station 120A and the base station 120B that occurred within a period of time has exceeded a predetermined threshold, when the received metrics from the user device 110 are within a predetermined range of values, and/or when the user device 110 is classified as a stationary device. Such conditions related to the repeated handovers, received metrics, and classification of the user device 110 may be indicative of ping-pong handover events having occurred and/or being likely to occur if further handovers are not prevented.

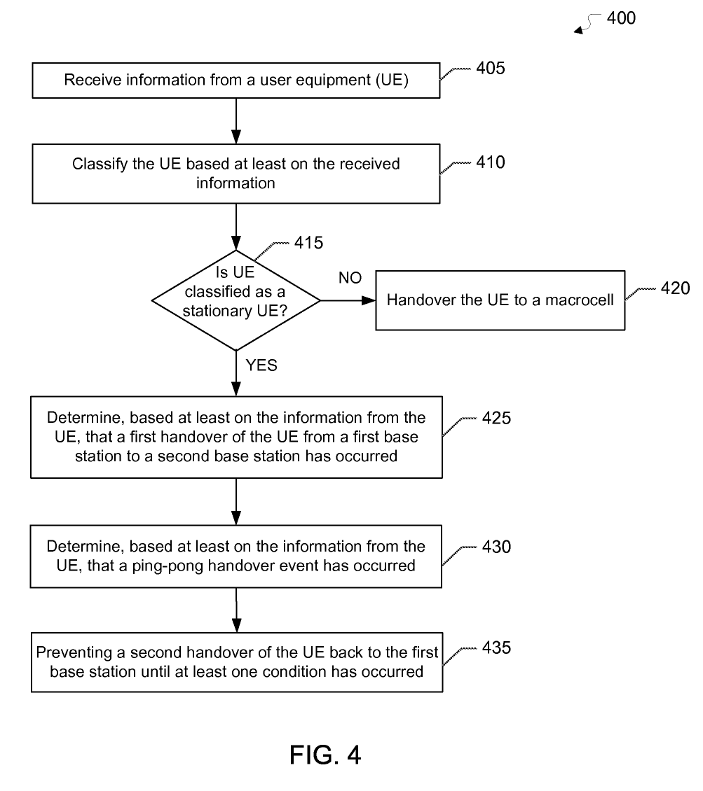

FIG. 4 illustrates a flow diagram of an example process 400 of a serving base station in a system for mitigating excessive handovers in accordance with one or more implementations. For explanatory purposes, the example process 400 is described herein with reference to the base station 120A of the example network environment 100 of FIG. 1; however, the example process 400 is not limited to the base station 120A of the example network environment 100 of FIG. 1, and the example process 400 may be performed by one or more components of the base station 120A, such as a base station processor and/or a cellular radio module. Furthermore, in one or more implementations, one or all of the blocks of the example process 400 may be performed by one or more components of the network management system 130. The blocks of example process 400 are described herein as occurring in serial, or linearly. However, multiple blocks of example process 400 may occur in parallel. In addition, the blocks of example process 400 need not be performed in the order shown and/or one or more of the blocks of example process 400 need not be performed. Furthermore, some of the blocks of example process 400 may be performed in a manner similar to corresponding blocks of example process 200 of FIG. 2 and/or corresponding blocks of example process 300 of FIG. 3.

Further for explanatory purposes, for the example process 400 the base station 120A is the serving base station for the user device 110 and the base stations 120B-D are neighboring base stations of the base station 120A. However, in one or more implementations, one or more of the base stations 120B-D may also be the serving base station of the user device 110.

The base station 120A receives information from the user device 110 (405). In one or more implementations, the information may be, and/or may include, UE history information indicating which base stations have served as a serving base station for the user device 110 and/or may be, may include, or may be utilized by the base station 120A to derive, one or more metrics (e.g., RSRP, RSRQ, SINR, RTT).

The base station 120A classifies the user device 110 based at least on the information received from the user device 110 (410). The classification may be based on the received metrics, e.g., the serving base station RSRP variances. The user device 110 may be classified as a high mobility device, a normal mobility device, or a stationary (e.g., no mobility or low mobility) device. Additional, different, or fewer classifications may be utilized.

The base station 120A determines if the user device 110 is classified as a stationary mobility device (415). If the user device 110 is not classified as a stationary mobility device (e.g., normal mobility device, high mobility device), the base station 120A may hand over the user device 110 to a macrocell (e.g., the base station 120D) (420). In some aspects, the base station 120A may handle a normal mobility device differently from a high mobility device, as discussed further above with respect to FIG. 3.

If the user device 110 is classified as a stationary mobility device, the base station 120A determines that a handover of the user device 110 from the base station 120B to the base station 120A has occurred (425). The handover of the user device 110 from the base station 120B to the base station 120A may be the most recent handover of the user device 110. The base station 120A may determine that the handover from the base station 120B has occurred based at least on the information received from the user device 110, such as the UE history information.

The base station 120A determines that a ping-pong handover event has occurred between the base station 120A and the base station 120B (430). The base station 120A may determine that a ping-pong handover event has occurred based at least on the information received from the user device 110. The ping-pong handover event may be determined to have occurred based on the UE history information and/or UE metric reports (e.g., UE RSRP report), such as when the user device 110 is handed over from the base station 120A to the base station 120B, and then is subsequently handed over from the base station 120B back to the base station 120A.

In one or more implementations, the base station 120A determines that a ping-pong handover event has occurred when the UE history information indicates that the user device 110 has been handed over between the base station 120A and the base station 120B a multiple number of times and/or within a short amount of time (e.g., 5 seconds). For example, the base station 120A may determine that a ping-pong handover event has occurred when two or more repeated handovers from the base station 120A to the base station 120B has occurred within a time duration of 5 seconds. The base station 120A may store the number of repeated handovers as a counter that is incremented, e.g., each time a handover of the user device 110 from the base station 120A to the base station 120B occurs. The repeated handovers between any two base stations may be, but need not be, consecutive handover events. In some aspects, the threshold number of repeated handovers and/or the associated period of time are set based on one or more performance metrics of the base station 120A, such as ping-pong detection reliability and/or ping-pong handover event rate.

In addition to the UE history information, the base station 120A may also utilize the received metrics to determine that a ping-pong handover event has occurred. For example, the base station 120A may determine that a ping-pong handover event has occurred when the received metrics from the user device 110 is within one or more predetermined ranges of values in addition to the UE history information indicating that the user device 110 has been handed over between the base station 120A and the base station 120B a multiple number of times and/or within a short amount of time. The received metrics may be an RSRP difference between the base station 120A and the base station 120B and/or an RSRP variance, which may be provided in and/or derived by the base station 120A from one or more UE RSRP reports.

Based on the determination that the user device 110 was handed over to the base station 120A from the base station 120B, the base station 120A prevents a handover of the user device 110 back to the base station 120B unless (or until) one or more conditions have occurred and/or until one or more criteria have been satisfied (435). The prevention of the handover back to the base station 120B until one or more conditions have occurred and/or one or more criteria have been satisfied may facilitate mitigating excessive handovers, including mitigating ping-pong handover events.

FIG. 5 conceptually illustrates an electronic system 500 with which one or more implementations of the subject technology may be implemented. The electronic system 500, for example, can be a laptop computer, a tablet computer, an integrated access device, a wireless access point, a router, a base station, a receiver, a mobile phone, or generally any electronic device that wirelessly transmits signals. The electronic system 500 can be, and/or can be a part of, one or more of the user device 110, the base stations 120A-D, and the network management system 130 shown in FIG. 1. Such an electronic system includes various types of computer readable media and interfaces for various other types of computer readable media. The electronic system 500 includes a bus 508, one or more processing unit(s) 512, a system memory 504 (and/or buffer), a read-only memory (ROM) 510, a permanent storage device 502, an input device interface 514, an output device interface 506, and one or more network interfaces 516, or subsets and variations thereof.

The bus 508 collectively represents all system, peripheral, and chipset buses that communicatively connect the numerous internal devices of the electronic system 500. In one or more implementations, the bus 508 communicatively connects the one or more processing unit(s) 512 with the ROM 510, the system memory 504, and the permanent storage device 502. From these various memory units, the one or more processing unit(s) 512 retrieves instructions to execute and data to process in order to execute the processes of the subject disclosure. The one or more processing unit(s) 512 can be a single processor or a multi-core processor in different implementations.

The ROM 510 stores static data and instructions that are needed by the one or more processing unit(s) 512 and other modules of the electronic system 500. The permanent storage device 502, on the other hand, may be a read-and-write memory device. The permanent storage device 502 may be a non-volatile memory unit that stores instructions and data even when the electronic system 500 is off. In one or more implementations, a mass-storage device (such as a magnetic or optical disk and its corresponding disk drive) may be used as the permanent storage device 502.

In one or more implementations, a removable storage device (such as a floppy disk, flash drive, and its corresponding disk drive) may be used as the permanent storage device 502. Like the permanent storage device 502, the system memory 504 may be a read-and-write memory device. However, unlike the permanent storage device 502, the system memory 504 may be a volatile read-and-write memory, such as random access memory. The system memory 504 may store any of the instructions and data that one or more processing unit(s) 512 may need at runtime. In one or more implementations, the processes of the subject disclosure are stored in the system memory 504, the permanent storage device 502, and/or the ROM 510. From these various memory units, the one or more processing unit(s) 512 retrieves instructions to execute and data to process in order to execute the processes of one or more implementations.

The bus 508 also connects to the input and output device interfaces 514 and 506. The input device interface 514 enables a user to communicate information and select commands to the electronic system 500. Input devices that may be used with the input device interface 514 may include, for example, alphanumeric keyboards and pointing devices (also called cursor control devices). The output device interface 506 may enable, for example, the display of images generated by electronic system 500. Output devices that may be used with the output device interface 506 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 5, the bus 508 also couples the electronic system 500 to one or more networks through the one or more network interface(s) 516. In this manner, the electronic system 500 can be a part of a network of computers (such as a local area network (LAN), a wide area network (WAN), or an Intranet, or a network of networks, such as the Internet. Any or all components of the electronic system 500 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In some implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

In one or more implementations, a computer program product (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more implementations are performed by one or more integrated circuits, such as application specific integrated circuits (ASICs) or field programmable gate arrays (FPGAs). In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

1. A device, comprising:
at least one processor circuit configured to:
receive information from a user equipment (UE), wherein the information comprises power values associated with the device;
determine, based at least on the information received from the UE, that a first handover of the UE from a first base station to the device has occurred;
classify the UE as one of a plurality of UE types by comparing a variance of the power values with a threshold variance; and
prevent a second handover of the UE from the device back to the first base station at least until an elapse of a time duration when the UE is classified as the one of the plurality of UE types, wherein the time duration is based at least in part on the variance of the power values.

2. The device of claim 1, wherein the first handover comprises a most recent handover of the UE.

3. The device of claim 1, wherein
the time duration is inversely proportional to the variance of the power values.

4. (canceled)

5. The device of claim 1, wherein the at least one processor circuit is configured to: determine that the first handover and one or more handovers prior to the first handover occurred, the one or more handovers being handovers of the UE between the first base station and the device.

6. The device of claim 5, wherein the at least one processor circuit is configured to: prevent the second handover when the one or more handovers and the first handover occur within a predetermined period of time.

7. The device of claim 1, wherein the at least one processor circuit is further configured to:
prevent the second handover by removing the first base station from a table of neighboring base stations for the device; and
add the first base station back to the table of neighboring base stations for the device when the time duration has elapsed.

8. The device of claim 1, wherein the at least one processor circuit is further configured to:
determine that a ping-pong handover event has occurred when a number of handovers of the UE between the first base station and the device that occur within a period of time exceeds a threshold number.

9. A method, comprising:
receiving information associated with a user equipment (UE);
determining, based at least on the received information, that a first handover of the UE from a first base station has occurred; and
preventing a second handover of the UE to the first base station until at least one condition has occurred by updating a table to indicate the first base station as a neighboring base station, wherein the at least one condition comprises an elapse of a time duration; and
updating the table to indicate the first base station as the neighboring base station when the time duration has elapsed.

10. (canceled)

11. The method of claim 9, wherein:
the information comprises one or more metrics associated with the first base station, and
the time duration is based at least on the one or more metrics.

12. The method of claim 11, wherein the one or more metrics comprise power values associated with the first base station.

13. The method of claim 9, wherein the preventing comprises updating the table to remove the first base station as the neighboring base station, and wherein the updating the table to indicate the first base station as the neighboring base station when the time duration has elapsed comprises updating the table to add the first base station as the neighboring base station when the time duration has elapsed.

14. (canceled)

15. The method of claim 9, wherein the first handover of the UE comprises a most recent handover of the UE.

16. The method of claim 9, wherein the determining that the first handover has occurred further comprises determining that one or more handovers prior to the first handover occurred, the one or more handovers and the first handover being handovers of the UE between the first base station and a second base station that is presently serving the UE.

17. The method of claim 16, wherein the one or more handovers and the first handover occur within a predetermined period of time.

18. A computer program product comprising instructions stored in a non-transitory tangible computer-readable storage medium, the instructions comprising:
instructions to receive information from a user equipment (UE), wherein the information comprises a value of a metric associated with a first base station;
instructions to determine, based at least on the information received from the UE, that a first handover of the UE from the first base station has occurred, wherein the first handover of the UE comprises a most recent handover of the UE;
instructions to classify the UE as one of a plurality of UE types based on the value of the metric and a threshold value;
instructions to prevent a second handover of the UE back to the first base station until one or more criteria have been satisfied when the UE is classified as the one of the plurality of UE types, wherein the one or more criteria are based at least in part on the value of the metric; and
instructions to allow the second handover of the UE back to the first base station when the one or more criteria have been satisfied.

19. The computer program product of claim 18, wherein the one or more criteria comprise an elapse of a time duration.

20. The computer program product of claim 19, wherein
the time duration is based at least on the value of the metric.

21. The computer program product of claim 19, wherein:
the value comprises a variance of power values associated with the first base station, and
the time duration is inversely proportional to the variance of the power values.

22. The computer program product of claim 19, wherein:
the value comprises a variance of power values associated with the first base station, and
the time duration is inversely related to the variance of the power values.

23. The device of claim 1, wherein the time duration is inversely related to the variance of the power values.
